(19) United States
(12) Patent Application Publication
(10) Pub. No.: US 2022/0391924 A1
(43) Pub. Date: Dec. 8, 2022

(54) METHODS AND APPARATUSES FOR AUTHENTICATING ASSETS

(71) Applicant: AUTHENTICITI INC, San Francisco, CA (US)

(72) Inventors: Andrew YANG, Toronto (CA); Athanasios KARACHOTZITIS, Toronto (CA); Jeong Woo PARK, Toronto (CA)

(21) Appl. No.: 17/833,263

(22) Filed: Jun. 6, 2022

Related U.S. Application Data
(60) Provisional application No. 63/196,913, filed on Jun. 4, 2021.

(51) Int. Cl. G06Q 30/00; H04L 9/32; H04L 9/00

(52) U.S. Cl. CPC G06Q 30/0185; H04L 9/3213; H04L 9/3247; H04L 9/3236; H04L 9/50

(57) ABSTRACT

Aspects of the present disclosure include methods, apparatuses, and computer readable media for receiving an indication of an asset of a manufacturer and a code associated with the asset, generating a token linked to a blockchain of the manufacturer, wherein the token includes a digital signature created using a creation key of the manufacturer, associating the token to the code of the asset, wherein the token remains locked until an indication is received, receiving the indication indicating the asset has passed a point of a supply chain and unlocking the token in response to receiving the indication.

### CROSS-REFERENCE TO RELATED APPLICATIONS

The current Application claims priority to, and the benefit of, U.S. Provisional Application No. 63/196,913 filed Jun. 4, 2021 and entitled “METHODS AND APPARATUSES FOR AUTHENTICATING ASSETS,” the contents of which are hereby incorporated by reference in their entireties.

### TECHNICAL FIELD

The present disclosure relates to deterring and/or detecting counterfeit products.

### BACKGROUND

Unauthorized manufacturers may produce counterfeit products and flood the market with the counterfeit products. These actions may have deleterious effects on the legitimate manufacturer because the counterfeit products may dilute the profit from selling the authentic products and/or cause loss in consumer confidence in the legitimate manufacturer due to lower qualities of the counterfeit products. Further, counterfeit products may cause harm to consumers due to reduced quality control and/or safety standards during manufacturing (e.g., using toxic paint materials, parts that may easily break or be swallowed by young children, etc.). While anti-counterfeit measures exist, conventional anti-counterfeit measures may be insufficient against more sophisticated counterfeiting techniques. Therefore, improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include methods, apparatuses, and computer readable media for receiving an indication of an asset of a manufacturer and a code associated with the asset, generating a token linked to a blockchain of the manufacturer, wherein the token includes a digital signature created using a creation key of the manufacturer, associating the token to the code of the asset, wherein the token remains locked until an indication is received, receiving the indication indicating the asset has reached a point of a supply chain and unlocking the token in response to receiving the indication.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for authenticating an asset in accordance with aspects of the present disclosure;

FIG. 2 illustrates an example of a method for authenticating an asset in accordance with aspects of the present disclosure;

FIG. 3 illustrates an example of a computer system in accordance with aspects of the present disclosure; and

FIG. 4 illustrates a block diagram of various example system components in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a bus that interconnects components such as Controller Area network (CAN), Local Interconnect Network (LIN), among others.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected”, is one in which signals, physical communications, and/or logical communications can be sent and/or received. An operable connection can include a physical interface, a data interface and/or an electrical interface.

An aspect of the present disclosure relates to authenticating assets using blockchain. A vendor may manufacture an asset (e.g., merchandise, instrument, tool, etc.) at a manufacturing facility. The vendor may create a unique code associated with the asset. Next, a blockchain provider may generate a token associated with a blockchain of the vendor. The token may be generated using a creation key belonging to the vendor. Once created, the token may be associated with the unique code. The token may be locked until the asset reaches a certain point in the supply chain (e.g., shipped from a distribution warehouse). Once the blockchain provider receives an indication indicating that the asset has reached the point in the supply chain, the blockchain provider may unlock the token for asset registration. A consumer may purchase the asset, and provide the unique code to the blockchain provider. Upon receiving the unique code, the blockchain provider may 1) verify that the associated asset is authentic (i.e., not counterfeit), and/or 2) register the consumer as the owner of the asset.

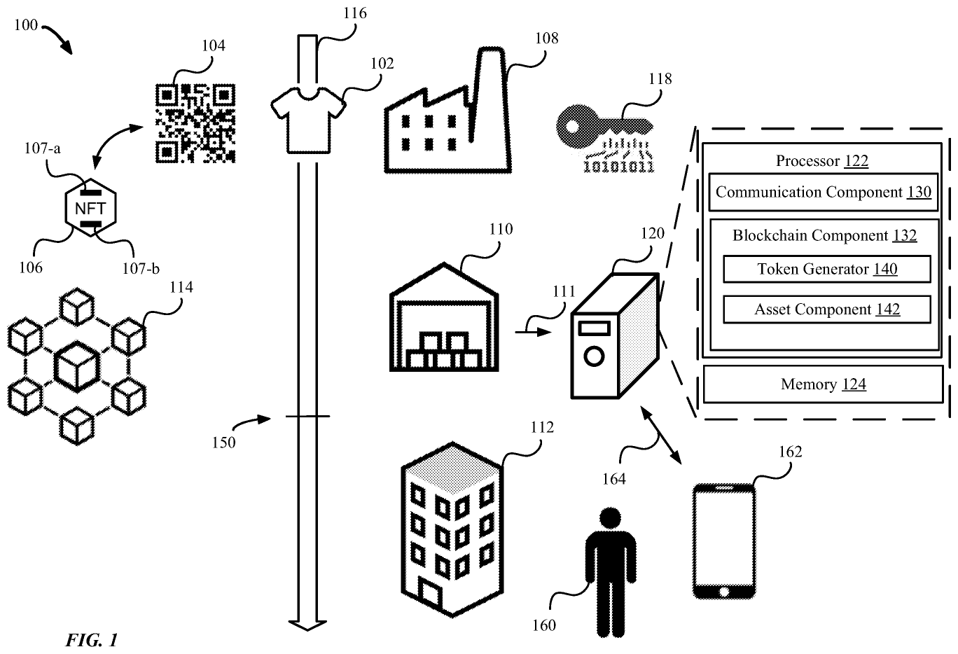

Turning to FIG. 1, in some aspects of the present disclosure, an environment 100 for authenticating assets may include a manufacturing facility 108 that manufactures an asset 102. The manufacturing facility 108 may be owed, operated, and/or controlled by a manufacturer (not shown) of products for sale. The environment 100 may include a distribution center 110 that distributes manufactured assets (such as the asset 102) to retail stores, warehouses, etc., such as a retail store 112. A supply chain 116 may illustrate the movements of the manufactured assets from the manufacturing facility 108, to the distribution center 110, and then to the retail store 112.

In some implementations, the environment 100 may include a blockchain system 120 having a processor 122 and a memory 124. The processor 122 may include a communication component 130 configured to communicate via wired or wireless connections with other devices. The processor 122 may include a blockchain component 132 configured to create, modify, maintain, and/or delete blockchains, blocks of blockchains, and/or other records of the blockchain. For example, the blockchain component 132 may include a token generator 140 configured to generate tokens of blockchains. The blockchain component 132 may include an asset component 142 configured to verify assets/tokens. The memory 124 may store blockchains. The blockchain system 120 may include physical servers and/or cloud-based virtual systems.

In some aspects of the current disclosure, during normal operation, the manufacturing facility 108 may manufacture the asset 102. The manufacturing facility 108 and/or the manufacturer (not shown) may generate a unique code 104. Examples of the unique code 104 may include Quick Response (QR) code, a barcode, a PDF417 code, a data matrix, or other suitable product codes. The unique code 104 may be associated with the asset 102. For example, the unique code 104 may be printed on the packaging of the asset 102 and/or directly onto the asset 102.

In certain implementations, the manufacturing facility 108 (and/or the manufacturer) may transmit the unique code 104 and/or information relating to the asset 102 to the blockchain system 120. Upon receiving the unique code 104, the blockchain system 120, the processor 122, the blockchain component 132, and/or the token generator 140 may generate a token 106 having a digital signature 107-b. The digital signature 107-b may be created using a token identifier (ID) 107-a and/or a creation key 118. For example, the blockchain system 120, the processor 122, the blockchain component 132, and/or the token generator 140 may use a hash function (with the token ID 107-a and the creation key 118 as input values) to generate the digital signature 107-b. Other methods of creating the digital signature 107-b may also be utilized. The creation key 118 may be an alphanumeric string known to the manufacturing facility 108 (and/or the manufacturer). The manufacturing facility 108 may keep the creation key 118 secret to prevent unauthorized generation of tokens. The token 106 may be appended as a record in a blockchain 114 associated with the manufacturing facility 108 (and/or the manufacturer). The blockchain 114 may include records of the authenticated assets manufactured by the manufacturing facility 108 and/or owned by the manufacturer. The blockchain 114 may be stored in the memory 124 and/or other suitable storage medium.

In some implementations, the blockchain system 120, the processor 122, the blockchain component 132, and/or the asset component 142 may associate the token 106 with the unique code 104. The token 106 may be used to authenticate the asset 102 later in the supply chain 116. The token 106 may be hidden from unauthorized access.

In certain aspects of the present disclosure, the blockchain system 120, the processor 122, the blockchain component 132, and/or the asset component 142 may lock the token 106 from being claimed until the asset 102 reaches a certain point in the supply chain 116, such as a point 150. At point 150, the blockchain system 120, the processor 122, the blockchain component 132, and/or the asset component 142 may unlock the token 106 in response to receiving an indication 111. Point 150 may occur after the asset 102 has been shipped from the distribution center 110, for example. The distribution center 110 may transmit the indication 111 to the blockchain system 120 that the asset 102 has left the distribution center 110 for delivery. The asset 102 may be on the way to the retail store 112. In other examples, the asset 102 may be locked after the asset 102 has been manufactured, until the asset 102 reaches the distribution center 110, or until the asset 102 reaches the retail store 112. In alternative implementations, the blockchain system 120, the processor 122, the blockchain component 132, and/or the asset component 142 may unlock the token 106 based on a predetermined amount of time (e.g., after a scheduled delivery from the distribution center 110 to the retail store 112) or distance, among other factors.

In an implementation, after the asset 102 reaches the retail store 112, a consumer 160 may purchase the asset 102. After the purchase, the consumer 160 may obtain the code 104 by scanning and/or inputting a code with a device 162, such as a mobile device. For example, the consumer 160 may use the device 162 to scan the code 104 (e.g., QR code). The device 162 may transmit the code 104 (and/or information in the code 104) to the blockchain system 120, via a communication link 162, to authenticate the asset 102.

In some implementations, the blockchain system 120, the processor 122, and/or the communication component 130 may receive the code 104 (and/or the information in the code 104) from the device 162. The blockchain system 120, the processor 122, the blockchain component 132, and/or the asset component 142 may determine whether there is a token associated with the code 104. The blockchain system 120, the processor 122, the blockchain component 132, and/or the asset component 142 may identify the token 106 as being associated with the code 104. As a result, the blockchain system 120, the processor 122, the blockchain component 132, and/or the asset component 142 may determine that the asset 102 has been properly authenticated as being manufactured by the manufacturing facility 108 (i.e., not a counterfeit asset).

In optional implementations, the blockchain system 120 and/or the processor may register the consumer 160 (via identification information associated with the consumer 160, such as login information, government issued ID, e-mail address, phone number, etc.) as the owner of the asset 102.

In a first alternative aspect, the blockchain system 120 may be configured to detect a counterfeit asset. If a counterfeiter manufactures a counterfeit asset with a code, the code will not be associated with any token in the blockchain 114. Therefore, if the consumer 160 purchases the counterfeit asset and attempts to authenticate, the authentication will fail because the code is not associated with any token in the blockchain 114. Therefore, the counterfeit asset will be identified as being not authentic. In some implementations, the blockchain system 120 may collect counterfeit information as described below. In other instances, the blockchain system 120 may notify the manufacturer and/or the buyer of the counterfeit item.

In a second alternative instance, the blockchain system 120 may be configured to detect a code that is associated with a token in the blockchain 114 but placed on a counterfeit asset. If a counterfeiter manufactures a counterfeit asset, and obtains (without authorization) a code that has been associated with an authentic asset and a token, the counterfeiter may attach the stolen code to the counterfeit asset. The counterfeiter may sell the counterfeit asset to a consumer prior to the token been unlocked. As a result, the consumer may attempt to register the counterfeit asset by offering the stolen code. However, since the token has not been unlocked, the blockchain system 120 may determine that the authentic asset has not been available for purchase (e.g., still in the supply chain 116 and before reaching the retail store 112). As a result, the blockchain system 120 may refrain from registering the counterfeit asset (or the stolen code). In some implementations, the blockchain system 120 may collect counterfeit information as described below.

In a third alternative instance, the blockchain system 120 may be configured to detect a code that is associated with a token in the blockchain 114 but placed on a counterfeit asset. If a counterfeiter manufactures a counterfeit asset, and obtains (without authorization) a code that has been associated with an authentic asset and a token, the counterfeiter may attach the stolen code to the counterfeit asset. The counterfeiter may sell the counterfeit asset to a consumer after the authentic asset has been registered using the code (shown on the authentic asset). As a result, the consumer may attempt to register the counterfeit asset by offering the code (stolen by the counterfeiter). However, since the authentic asset has already been registered, the blockchain system 120 may determine that the consumer requesting the registration just purchased the counterfeit asset that was manufactured without authorization. In some implementations, the blockchain system 120 may collect counterfeit information as described below.

In some implementations, the blockchain system 120 may gather information relating to detected counterfeit assets. For example, the blockchain system 120 may collect information regarding a number of counterfeit assets detected for a product type, geographic locations of the detected counterfeit assets, or other relevant data. The collected information may be used to track counterfeiter origins, identify “popular” assets targeted by counterfeiters, etc. In other instances, the blockchain system 120 may notify the manufacturer and/or the buyer of the counterfeit item.

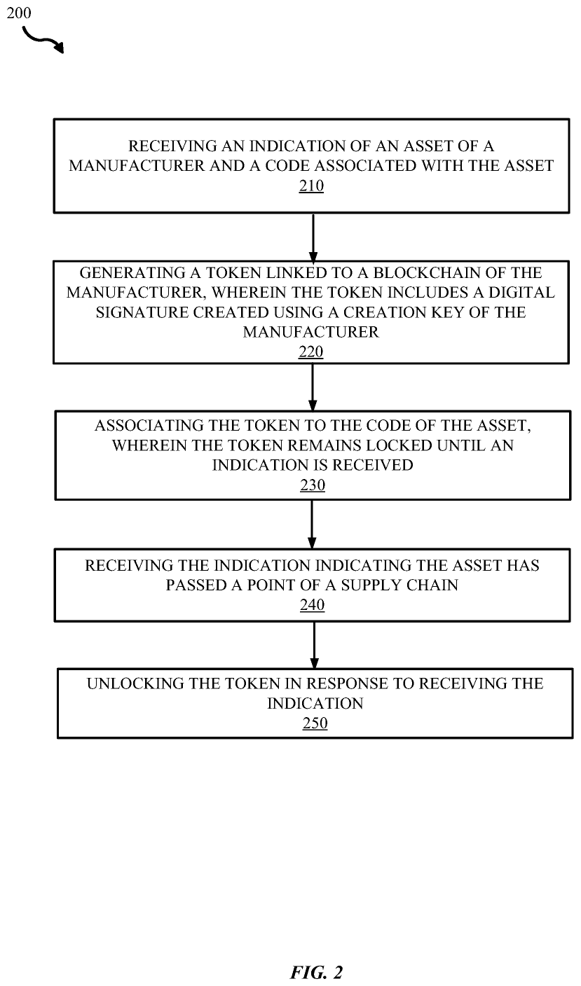

Turning to FIG. 2, a method 200 of authenticating an asset may be performed by the blockchain system 120, the processor 122, the communication component 130, the blockchain component 132, the token generator 140, and/or the asset component 142.

At block 210, the method 200 may receive an indication of an asset of a manufacturer and a code associated with the asset. For example, the blockchain system 120, the processor 122, and/or the communication component 130 may receive an indication of the asset 102 and the code 104.

At block 220, the method 200 may generate a token linked to a blockchain of the manufacturer, wherein the token includes a digital signature created using a creation key of the manufacturer. For example, the blockchain system 120, the processor 122, the blockchain component 132, and/or the token generator 140 may generate the token 106 having the digital signature 107-b created using the creation key 118.

At block 230, the method 200 may associate the token to the code of the asset, wherein the token remains locked until an indication is received. For example, the blockchain system 120, the processor 122, the blockchain component 132, and/or the asset component 142 may associate the token 106 to the code 104 of the asset 102.

At block 240, the method 200 may receive the indication indicating the asset has reached a point in a supply chain. For example, the blockchain system 120, the processor 122, and/or the communication component 130 may receive an indication that the asset 102 has reached point 150 in the supply chain 116.

At block 250, the method 200 may unlock the token in response to receiving the indication. For example, the blockchain system 120, the processor 122, the blockchain component 132, and/or the asset component 142 may unlock the token 106 in response to receiving the indication.

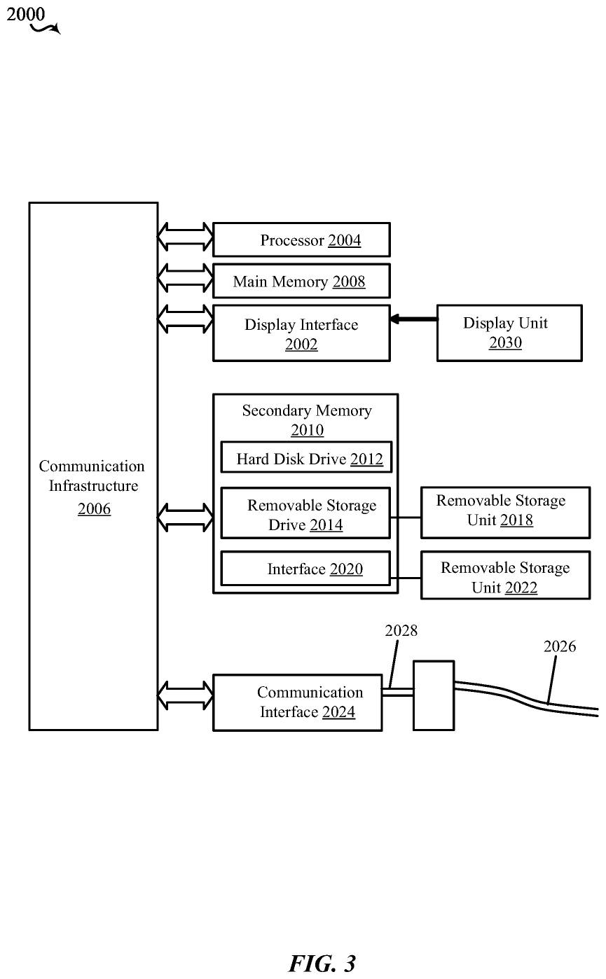

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. For example, the blockchain system 120 and/or the device 162 may be implemented as the computer system 2000. An example of such the computer system 2000 is shown in FIG. 3.

The computer system 2000 includes one or more processors, such as processor 2004. The processor 2004 is connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosures may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and the removable storage unit 2022 and interface 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage unit 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard disk drive 2012, or the interface 2020. The control logic (software), when executed by the processor 2004, causes the processor 2004 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

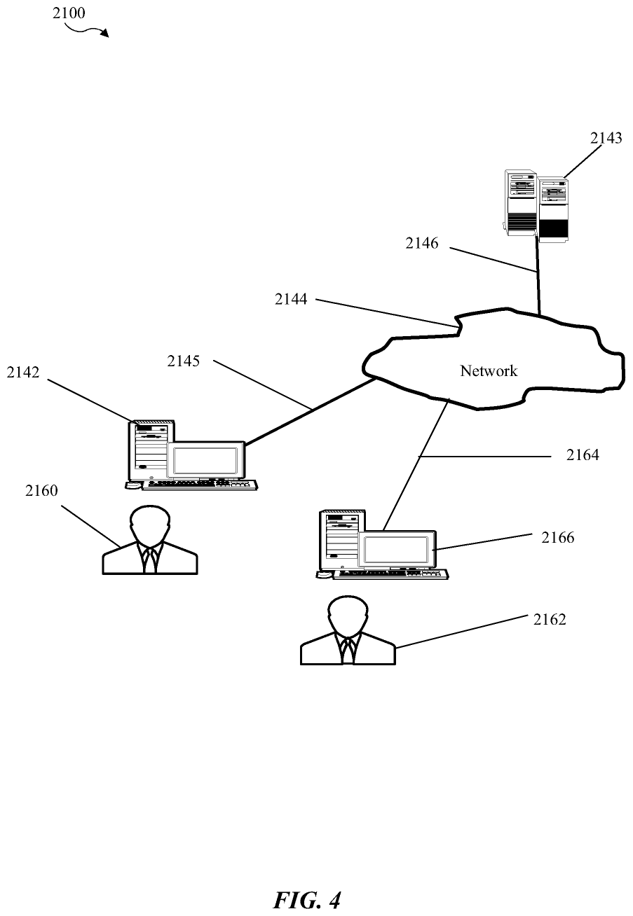

FIG. 4 is a block diagram of various example system components, in accordance with an aspect of the present disclosure. FIG. 1 shows a communication system 2100 usable in accordance with the present disclosure. The communication system 2100 includes one or more accessors 2160, 2162 (also referred to interchangeably herein as one or more “users”) and one or more terminals 2142, 2166. In one aspect, data for use in accordance with aspects of the present disclosure is, for example, input and/or accessed by the one or more accessors 2160, 2162 via the one or more terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of authenticating an asset, comprising:
receiving an indication of an asset of a manufacturer and a code associated with the asset;
generating a token linked to a blockchain of the manufacturer, wherein the token includes a digital signature created using a creation key of the manufacturer;
associating the token to the code of the asset, wherein the token remains locked until an indication is received;
receiving the indication indicating the asset has reached a point in a supply chain; and
unlocking the token in response to receiving the indication.

2. The method of claim 1, further comprising:
receiving, after unlocking the token, a registration request from a consumer for registering the asset based on the code;
determining that the code is associated with the token and the asset has not been registered; and
registering the asset to the consumer.

3. The method of claim 2, wherein the registration request includes at least one of login information, a government issued identification number, an e-mail address, or a telephone number of the consumer.

4. The method of claim 1, wherein generating the token comprises generating the digital signature using a token identifier of the token and the creation key.

5. The method of claim 4, wherein generating the digital signature comprises applying a hash function to at least a portion of the token identifier and at least a portion of the creation key.

6. The method of claim 1, further comprising:
receiving, before unlocking the token, a registration request from a consumer for the asset based on the code; and
determining that the registration request is invalid.

7. The method of claim 1, further comprising:
receiving a registration request from a consumer for a second asset based on a second code;
determining that the second code is not associated with any token of the blockchain; and
determining that the second asset is a counterfeit asset.

8. The method of claim 7, further comprising:
receiving a registration request from a consumer for a third asset based on the code;
determining that the code is associated with the token and the third asset has been registered; and
determining that the third asset is a counterfeit asset.

9. A system for authenticating an asset, comprising:
a memory having instructions; and
one or more processors communicatively coupled to the memory and configured to:
receive an indication of an asset of a manufacturer and a code associated with the asset;
generate a token linked to a blockchain of the manufacturer, wherein the token includes a digital signature created using a creation key of the manufacturer;
associate the token to the code of the asset, wherein the token remains locked until an indication is received;
receive the indication indicating the asset has reached a point in a supply chain; and
unlock the token in response to receiving the indication.

10. The system of claim 9, wherein the one or more processors are further configured to:
receive, after unlocking the token, a registration request from a consumer for registering the asset based on the code;
determine that the code is associated with the token and the asset has not been registered; and
register the asset to the consumer.

11. The system of claim 10, wherein the registration request includes at least one of login information, a government issued identification number, an e-mail address, or a telephone number of the consumer.

12. The system of claim 9, wherein generating the token comprises generating the digital signature using a token identifier of the token and the creation key.

13. The system of claim 12, wherein generating the digital signature comprises applying a hash function to at least a portion of the token identifier and at least a portion of the creation key.

14. The system of claim 9, wherein the one or more processors are further configured to:
receive, before unlocking the token, a registration request from a consumer for the asset based on the code; and
determine that the registration request is invalid.

15. The system of claim 9, wherein the one or more processors are further configured to:
receive a registration request from a consumer for a second asset based on a second code;
determine that the second code is not associated with any token of the blockchain; and
determine that the second asset is a counterfeit asset.

16. The system of claim 15, wherein the one or more processors are further configured to:
receive a registration request from a consumer for a third asset based on the code;
determine that the code is associated with the token and the third asset has been registered; and
determine that the third asset is a counterfeit asset.

17. A non-transitory computer readable medium having instructions for authenticating an asset that, when executed by one or more processors, causes the one or more processors to:
receive an indication of an asset of a manufacturer and a code associated with the asset;
generate a token linked to a blockchain of the manufacturer, wherein the token includes a digital signature created using a creation key of the manufacturer;
associate the token to the code of the asset, wherein the token remains locked until an indication is received;
receive the indication indicating the asset has reached a point in a supply chain; and
unlock the token in response to receiving the indication.

18. The non-transitory computer readable medium of claim 17, further comprising instructions for:
receiving, after unlocking the token, a registration request from a consumer for registering the asset based on the code;
determining that the code is associated with the token and the asset has not been registered; and
registering the asset to the consumer.

19. The non-transitory computer readable medium of claim 18, wherein the registration request includes at least one of login information, a government issued identification number, an e-mail address, or a telephone number of the consumer.

20. The non-transitory computer readable medium of claim 17, wherein the instructions for generating the token comprises instructions for generating the digital signature using a token identifier of the token and the creation key.
